(19) United States
(12) Patent Application Publication
(10) Pub. No.: US 2026/0209537 A1
(43) Pub. Date: Jul. 23, 2026

(54) Ink Jet Ink Composition, Recording Method, Ink Set, And Pigment Dispersion Liquid

(71) Applicant: SEIKO EPSON CORPORATION, Tokyo (JP)

(72) Inventors: Tetsuya AOYAMA, Shiojiri (JP); Kenta KIKUCHI, Suwa (JP)

(21) Appl. No.: 19/454,819

(22) Filed: Jan. 21, 2026

(30) Foreign Application Priority Data
Jan. 22, 2025 (JP) 2025-009203

(51) Int. Cl. C09D 11/326; C09D 11/033; C09D 11/037; C09D 11/107; C09D 11/40; C09D 17/00

(52) U.S. Cl. CPC C09D 11/326; C09D 11/033; C09D 11/037; C09D 11/107; C09D 11/40; C09D 17/001; C09D 17/005

(57) ABSTRACT

An ink jet ink composition contains a pigment that is bio-derived carbon black and a solvent. The pigment is a resin-dispersed pigment dispersed with a crosslinked resin, and the solvent contains water. The ink jet ink composition is a water-based ink.

The present application is based on, and claims priority from JP Application Serial Number 2025-009203, filed Jan. 22, 2025, the disclosure of which is hereby incorporated by reference herein in its entirety.

### BACKGROUND

### 1. Technical Field

The present disclosure relates to an ink jet ink composition, a recording method, an ink set, and a pigment dispersion liquid.

### 2. Related Art

An ink jet recording method can record high-definition images with a relatively simple apparatus and has been rapidly developed in various fields. For example, for the purpose of providing a water-based ink jet ink composition having excellent environmental friendliness and storage stability, JP-A-2023-128719 describes an ink jet ink composition that is a water-based ink jet ink composition and contains a biologically derived color material, a biologically derived dispersant, and a biologically derived organic solvent, in which the organic solvent has a solubility parameter of 24.0 (cal/cm³)^{1/2} or more based on the Hansen method and contains a compound having a hydroxyl group.

In a water-based ink jet ink containing a pigment, it is desired to further improve ejection stability and the like.

### SUMMARY

An ink jet ink composition according to an aspect of the present disclosure contains a pigment that is bio-derived carbon black and a solvent. The pigment is a resin-dispersed pigment dispersed with a crosslinked resin, and the solvent contains water. The ink jet ink composition is a water-based ink.

A recording method according to an aspect of the present disclosure includes an attaching step of ejecting an ink using the ink jet ink composition described above from an ink jet head to attach the ink to a recording medium.

An ink set according to an aspect of the present disclosure includes the ink jet ink composition described above.

A pigment dispersion liquid according to an aspect of the present disclosure is a pigment dispersion liquid for use in preparing an ink jet ink composition and contains a pigment that is bio-derived carbon black and a solvent. The pigment is a resin-dispersed pigment dispersed with a crosslinked resin, and the solvent contains water. The pigment dispersion liquid is a water-based pigment dispersion liquid.

### BRIEF DESCRIPTION OF THE DRAWINGS

FIG. 1 is a diagram showing an example of a recording apparatus used in the present embodiment.

FIG. 2 is Table 1 showing the compositions of respective compositions used in the Examples and the evaluation results thereof.

### DESCRIPTION OF EMBODIMENTS

The present embodiment will be described below in detail with reference to the drawings as needed, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Further, the dimensional ratios in the drawings are not limited to the ratios shown in the drawings.

### 1. Ink Jet Ink Composition

An ink jet ink composition according to the present embodiment contains a pigment that is bio-derived carbon black (hereinafter also referred to as “bio-derived CB”) and a solvent, in which the pigment is a resin-dispersed pigment dispersed with a crosslinked resin, and the solvent contains water, and which is a water-based ink.

With respect to environmentally friendly inks, efforts have been made to reduce petroleum-derived components and reduce CO₂ emissions due to petroleum-derived components by using coloring materials derived from natural products, including bio-derived CBs such as biochar and bio-oil char.

Biochar is char obtained by the carbonization of organisms. Bio-oil char is char obtained by the carbonization of biologically derived oils. Bio-oils are oils made from organisms or obtained from organisms. Biochar is a carbonized product of an organism such as a solid that is not a bio-oil. Organisms are living organisms such as animals, plants, and microorganisms, and not derived from underground resources such as petroleum.

Biochar has many surface irregularities and a large specific surface area. In addition, it tends to have many active sites on the surface as a result of pulverization in the production process. Due to these factors, plant char is likely to aggregate, and thus the storage stability, the ejection stability, and the clogging recoverability may deteriorate.

In addition, bio-oil char contains more organic substances as impurities compared with petroleum-derived carbon black and the like. When organic components such as organic solvents and surfactants are enriched due to the evaporation of moisture in the ink, an interaction acts between organic substances contained in the bio-oil CB and these organic components, and a hydrophobic interaction between the bio-oil char and the dispersant resin can be weakened. As a result, the dispersant resin is eluted (liberated), and the pigment is likely to aggregate. Therefore, the storage stability, the ejection stability, and the clogging recoverability may deteriorate.

Further, the surface of a pigment derived from bio-oil char may have polymer organic substances as impurities adhering thereto. Such impurities easily detach from the pigment in the ink. The pigment surface after detachment tends to have high hydrophobicity, and is likely to be a starting point of pigment aggregation. Examples of such polymeric organic substances include fulvic acid.

From the viewpoint of improving the storage stability, ejection stability, and clogging recoverability of such a pigment derived from bio-oil char, it is also considered to increase the amount of the dispersant resin used. However, the amount of the dispersant resin liberated in the ink increases, and this may also rather deteriorate the ejection stability and the clogging recoverability.

Thus, in the present embodiment, bio-derived CB is used as a resin-dispersed pigment dispersed with a crosslinked dispersant resin. The crosslinked dispersant resin has high adsorption stability to pigments, leading to excellent dispersion stability of pigments, and thus can suppress aggregation. Therefore, the resulting ink has excellent storage stability, ejection stability, and clogging recoverability. In particular, even when the drying of the ink progresses, and organic components are enriched, the resulting ink is excellent in the above effects. In addition, it also becomes possible to reduce the total amount of the dispersant resin used.

The biomass degree of the ink composition of the present embodiment is preferably 50 to 100% by mass, 55 to 99% by mass, 65 to 97% by mass, 70 to 95% by mass, or 75 to 93% by mass. When the biomass degree of the ink composition is within the above range, the resulting ink composition further contributes to the reduction of CO₂ emissions. Here, the biomass degree is the mass ratio of bio-derived components to the solids in the ink.

Bio-derived components are components that use, as raw materials, organic resources originating from animals and plants, excluding fossil resources. In the present embodiment, plant-derived CB, for example, corresponds to a bio-derived component.

The biomass degree can be measured by a known method based on the concentration of ¹⁴C measured by accelerator mass spectrometry (AMS method). More specifically, it can be measured by the method described in the Examples.

Hereinafter, components that can be contained in the ink composition according to the present embodiment will be described in detail.

### 1.1. Pigment

Examples of the pigment include a self-dispersing pigment, which disperses itself without using a dispersant, and a dispersant-dispersed pigment, which is dispersed with a dispersant, depending on the dispersion form. A dispersant is a material with which a pigment is dispersed. Among dispersant-dispersed pigments, a pigment dispersed with a resin is a resin-dispersed pigment.

A resin-dispersed pigment is a pigment dispersed in a solvent through adsorption, adhesion, coating, or the like of a resin on the pigment surface. The resin used as a dispersant is typically a water-insoluble resin, a water-soluble resin, or the like. The pigment in the present embodiment uses a crosslinked resin as the dispersant. Hereinafter, the pigment dispersed with a crosslinked resin is also referred to as “crosslinked resin-dispersed pigment”. Since the pigment surface is at least partially coated with the crosslinked resin in this manner, even when plant-derived CB is used as the pigment, the resin is less likely to be detached from the pigment surface. As a result, the dispersion stability improves, and the resulting ink has excellent storage stability, ejection stability, and clogging recoverability.

The method for producing the crosslinked resin-dispersed pigment in the present embodiment is not particularly limited, and examples thereof include a method including a step of polymerizing a resin having a reactive functional group such as a carboxyl group or a hydroxyl group, a step of mixing the resin and a pigment, and a step of crosslinking the reactive functional group.

In the present embodiment, the crosslinked resin used as the dispersant resin is not particularly limited, and, for example, may be obtained by reacting a resin having a reactive functional group such as a carboxyl group or a hydroxyl group with a crosslinking agent having two or more functional groups which react with the reactive functional group. Among these, the crosslinked resin preferably includes an acrylic-based resin. The acrylic-based resin is a general term for a polymer containing at least a constituent unit derived from an acrylic monomer. The acrylic monomer is a monomer having a (meth)acryloyl group, such as (meth)acrylic acid, (meth)acrylate, (meth)acrylamide, or (meth)acrylonitrile.

When the crosslinked resin includes an acrylic-based resin, the storage stability, the ejection stability, and the clogging recoverability tend to be further improved. The resin and the crosslinking agent may be reacted in advance and then mixed with the pigment, or the resin may be mixed with the pigment and then reacted with the crosslinking agent.

Examples of the monomer constituting the resin having a reactive functional group include a monomer having an ionic group and a hydrophobic monomer. The resin having a reactive functional group may be a copolymer of a monomer having an ionic group or a hydrophobic monomer.

The monomer having an ionic group is not particularly limited, and examples thereof include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl)phosphate, diphenyl-2-acryloyloxyethyl phosphate, and diphenyl-2-methacryloyloxyethyl phosphate; unsaturated tertiary amine-containing monomers such as N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, N,N-dimethylallylamine, vinylpyrrolidone, 2-vinylpyridine, 4-vinylpyridine, 2-methyl-6-vinylpyridine, and 5-ethyl-2-vinylpyridine; and unsaturated ammonium salt-containing monomers such as quaternized N,N-dimethylaminoethyl (meth)acrylate, quaternized N,N-diethylaminoethyl (meth)acrylate, and quaternized N,N-dimethylaminopropyl (meth)acrylate.

The content of the constituent unit derived from the monomer having an ionic group is preferably 1 to 80% by mass, 10 to 50% by mass, 20 to 40% by mass, or 25 to 35% by mass with respect to the total amount of the dispersant resin. When the content of the constituent unit derived from the monomer having an ionic group is within the above range, the storage stability, the ejection stability, and the clogging recoverability tend to be further improved.

In addition, the hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl(meth)acrylate, cyclohexyl (meth)acrylate, 2-ethylhexyl (meth)acrylate, octyl (meth)acrylate, decyl(meth)acrylate, dodecyl (meth)acrylate, stearyl (meth)acrylate, isopropyl (meth)acrylate, isobutyl (meth)acrylate, tert-butyl (meth)acrylate, isoamyl(meth)acrylate, isooctyl (meth)acrylate, isodecyl(meth)acrylate, isododecyl (meth)acrylate, and isostearyl (meth)acrylate; and aromatic group-containing monomers such as styrene, α-methylstyrene, 2-methylstyrene, vinyltoluene, divinylbenzene, chlorostyrene, phenyl (meth)acrylate, benzyl (meth)acrylate, and phenoxyethyl (meth)acrylate.

The content of the constituent unit derived from the hydrophobic monomer is preferably 30 to 99% by mass, 50 to 90% by mass, 60 to 80% by mass, or 65 to 75% by mass with respect to the total amount of the dispersant resin. When the content of the constituent unit derived from the hydrophobic monomer is within the above range, the storage stability, the ejection stability, and the clogging recoverability tend to be further improved.

The polymerization initiator used for polymerizing the resin having a reactive functional group is not particularly limited, and examples thereof include 2,2′-azobis(2-amidinopropane)dibasic acid, 4,4′-azobis(4-cyanovaleric acid), 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(2-imidazolin-2-yl)propane]disulfate dihydrate, 2,2′-azobis[2-(3,4,5,6-tetrahydropyrimidin-2-yl)propane]dihydrochloride, 2,2′-azobis[2-(1-(2-hydroxyethyl)-2-yl)propane]dihydrochloride, 2,2′-azobis(2-methylpropionamidine) dihydrochloride, and 2,2′-azobis[N-(2-carboxyethyl)-2-methylpropionamide].

The polymerization chain transfer agent used for polymerizing the resin having a reactive functional group is not particularly limited, and examples thereof include polymerization chain transfer agents having an anionic group, such as 2-mercaptopropionic acid, 3-mercaptopropionic acid, mercaptosuccinic acid, thioglycolic acid, thiolactic acid, 4,4′-dithiobutyric acid, 3,3′-dithiopropionic acid, and dithioglycolic acid; polymerization chain transfer agents having a cationic group, such as 1-amino-2-methyl-2-propanethiol, 2-aminoethanethiol, 2-diethylaminoethanethiol, 2-dimethylaminoethanethiol, 4-aminothiophenol, dithiodianiline, 3,4,5,6-tetrahydro-2-pyrimidinethiol, and 2-mercaptothiazoline; and polymerization chain transfer agents having an amphoteric ionic group, such as DL-penicillamine, N-(2-mercaptopropionyl)glycine, DL-cysteine, DL-homocysteine, cystamine, DL-cystine, and like thiol group-containing amino acids, as well as derivatives thereof.

Examples of the crosslinking agent include those capable of reacting with the reactive functional group of the resin to form an ester bond, a thioester bond, an amide bond, an amino bond, an ether bond, a thioether bond, a carbonyl bond, a thiocarbonyl bond, a sulfonyl bond, or the like.

Such a crosslinking agent is not particularly limited, and examples thereof include compounds having two or more functional groups such as an epoxy group, an isocyanate group, an aziridino group, an amino group, and an oxazoline group in the molecule. Among these, a compound having two or more functional groups of at least one kind selected from the group consisting of an epoxy group, an isocyanate group, an aziridino group, an amino group, and an oxazoline group in the molecule is preferable. By using such a compound, the storage stability, the ejection stability, and the clogging recoverability tend to be improved.

Such a crosslinking agent is not particularly limited, and examples thereof include a polyfunctional epoxy compound having two or more epoxy groups in the molecule. The polyfunctional epoxy compound is not particularly limited, and examples thereof include polypropylene glycol diglycidyl ether, glycerol polyglycidyl ether, polyglycerol polyglycidyl ether, trimethylolpropane polyglycidyl ether, sorbitol polyglycidyl ether, pentaerythritol polyglycidyl ether, resorcinol diglycidyl ether, neopentyl glycol diglycidyl ether, and hydrogenated bisphenol A diglycidyl ether.

The addition amount of the crosslinking agent is preferably 20 to 80 mol %, 25 to 60 mol %, 30 to 50 mol %, or 35 to 45 mol % with respect to the total amount of reactive functional groups in the resin. When the addition amount of the crosslinking agent is within the above range, the redispersibility, the clogging recoverability, and the storage stability tend to be further improved.

The volume-average particle size D50 corresponding to a cumulative percentage of 50% of the pigment is preferably 30 nm or more and 200 nm or less, 50 nm or more and 110 nm or less, 70 nm or more and 105 nm or less, 80 nm or more and 100 nm or less, or 87 nm or more and 95 nm or less. When the volume-average particle size D50 is within the above range, the storage stability, the ejection stability, and the clogging recoverability tend to be further improved.

The volume-average particle diameter in the present embodiment can be measured with a particle size distribution measuring apparatus using a dynamic light scattering method as the measurement principle. In addition, it can be measured with a particle size distribution measuring apparatus using a dynamic and electrophoretic light scattering method as the measurement principle. Examples of such a particle size distribution measuring apparatus include “ELSZ-2000ZS” (trade name) manufactured by Otsuka Electronics Co., Ltd., which employs a homodyne optical system as a frequency analysis method.

The content of the pigment is preferably 0.1 to 15% by mass, 1 to 12% by mass, 2 to 9% by mass, or 3% to 7% by mass with respect to the total amount of the ink composition. When the content of the pigment is within the above range, the storage stability, the ejection stability, and the clogging recoverability tend to be further improved.

The content of the dispersant resin is preferably 0.1 to 10% by mass, 0.3 to 5% by mass, 1 to 4% by mass, or 2 to 3% by mass with respect to the total amount of the ink composition. When the content of the dispersant resin is within the above range, the storage stability, the ejection stability, and the clogging recoverability tend to be further improved.

The mass ratio of the dispersant resin to the pigment is preferably 0.05 to 0.8, 0.1 to 0.7, 0.2 to 0.6, or 0.25 to 0.5. When the mass ratio of the dispersant resin to the pigment is within the above range, the storage stability, the ejection stability, and the clogging recoverability tend to be further improved.

### 1.1.1. Bio-Derived CB

The resin-dispersed pigment in the present embodiment includes bio-derived CB. Bio-derived CB is carbon black that uses organisms as raw materials. Since this carbon black is derived from natural products, it is possible to reduce petroleum-derived components and contribute to the reduction of CO₂ emissions due to petroleum-derived components. The bio-derived CB is not particularly limited, and examples thereof include biochar and bio-oil char as described above.

Examples of organisms include animals, plants, and microorganisms. Among bio-derived CBs, plant-derived CB using plants as raw materials is preferable and useful in that plants, which serve as raw materials, are easy to obtain as relatively homogeneous materials in relatively large amounts, easy to handle, and easy to store.

Examples of the plant-derived CB include plant char obtained by carbonizing plants and plant oil char obtained by carbonizing plant oils (plant-derived oils). In biochar, when the organism is a plant, it is referred to as plant char, and in bio-oil char, when the bio-oil is a plant oil, it is referred to as plant oil char.

Plant char has many pigment surface irregularities as described above, has a large specific surface area, and also tends to have many active sites on the surface as a result of pulverization in the production process. Due to these factors, there is a particularly strong tendency that the storage stability, the ejection stability, and the clogging recoverability may deteriorate.

In addition, plant oil char contains a large amount of organic substances as impurities, and when organic components such as organic solvents and surfactants are enriched due to the evaporation of moisture in the ink, an interaction acts between organic substances contained in the plant oil CB and these organic components, and a hydrophobic interaction between the plant oil char and the dispersant resin may be weakened. As a result, the dispersant resin is eluted (liberated), and the pigment is likely to aggregate. Therefore, there is a particularly strong tendency that the storage stability, the ejection stability, and the clogging recoverability may deteriorate.

However, according to the present embodiment, even when plant-derived CB is used, excellent storage stability, ejection stability, clogging recoverability, and the like are obtained, and the present embodiment is particularly useful.

The content of the bio-derived CB is preferably 0.1 to 15% by mass, 1 to 12% by mass, 2 to 9% by mass, or 3 to 7% by mass with respect to the total amount of the ink composition. When the content of the bio-derived CB is within the above range, the storage stability, the ejection stability, and the clogging recoverability tend to be improved.

### 1.1.1.1. Plant Char

The resin-dispersed pigment in the present embodiment preferably includes plant char. The plant char is not particularly limited, and examples thereof include Binchotan charcoal, bamboo charcoal, activated carbon, white charcoal, black charcoal, molded wood charcoal, sawdust charcoal, plum coal, activated carbon, oak charcoal, Douglas fir charcoal, seaweed charcoal, mangrove charcoal, and coconut shell charcoal. The method for producing plant char is not particularly limited, and examples thereof include a method in which a plant is treated under high-temperature conditions and carbonized. The high-temperature condition is not particularly limited as long as it is a condition under which the plant can be carbonized, and examples thereof include a high-temperature condition of 250° C. or more known as “charcoal burning” under which a bamboo or wood plant can be turned into ash, a high-temperature condition of 350° C. or more under which uncarbonized components are considered to disappear, and a high-temperature condition of 700° C. or more using a charcoal kiln or the like.

The content of the plant char is preferably 0.1 to 15% by mass, 1 to 12% by mass, 2 to 9% by mass, or 3 to 7% by mass with respect to the total amount of the ink composition. When the content of the plant char is within the above range, the storage stability, the ejection stability, and the clogging recoverability tend to be further improved.

### 1.1.1.2. Plant Oil Char

The resin-dispersed pigment in the present embodiment preferably includes plant oil char. Plant oil char is obtained by carbonizing a plant oil into carbon black, and the production thereof is relatively easy since the production process is similar to that of petroleum-derived carbon black in that a liquid is combusted and carbonized.

The method for producing the plant oil char is not particularly limited, and, for example, a known method such as a furnace method, a channel method, or a lamp method is used. In addition, the structure of the plant oil char can also be controlled, in the preparation process for the raw material such as a plant oil or a modified product thereof, not only by adjusting the conditions such as the heating temperature and sample amount but also by adding an alkaline agent such as potassium hydroxide or sodium hydroxide, for example.

The raw material for the plant oil char is not particularly limited, and examples thereof include tall oil, wood tar, plant seed oil, and modified products of the above substances, such as hydrogenated products and derivatives. The modified products are products obtained by modifying plant oils within the scope in which the effect of the present embodiment can be obtained.

The content of the plant oil char is preferably 0.1 to 15% by mass, 1 to 12% by mass, 2 to 9% by mass, or 3 to 7% by mass with respect to the total amount of the ink composition. When the content of the plant oil char is within the above range, the storage stability, the ejection stability, and the clogging recoverability tend to be further improved.

### 1.2. Fixing Resin

The ink composition in the present embodiment preferably contains a fixing resin. A fixing resin is a resin that enhances the fixation of the pigment to the recording medium, and when the ink composition contains a fixing resin, the abrasion resistance and the like tend to be further improved. In the present embodiment, the fixing resin is distinguished from the dispersant resin.

On the other hand, when an ink contains a fixing resin, the ejection stability, the clogging recoverability, the storage stability, and the like may deteriorate. However, in the present embodiment, excellent ejection stability, clogging recoverability, storage stability, and the like are obtained, and the present embodiment is particularly useful.

The fixing resin is not particularly limited, and examples thereof include an acrylic-based resin, a urethane-based resin, a polyester-based resin, a polyether-based resin, and a polyolefin-based resin. The fixing resin may be a self-emulsifying resin, which stabilizes itself as a resin emulsion without using an emulsifier, or an emulsifier-emulsifying resin, which is stabilized as a resin emulsion using an emulsifier.

The fixing resin may be a water-soluble resin dissolved in a solvent component including water contained in the ink. The fixing resin is not a resin for dispersing the pigment, does not adhere or adsorb to the pigment in the ink, and is dissolved in the solvent component or dispersed as resin particles.

The fixing resin is preferably a resin dispersed as resin particles in the ink, a resin emulsion, or the like from the viewpoint of more excellent abrasion resistance and the like.

The content of the fixing resin is preferably 0.1 to 10% by mass, 0.1 to 5% by mass, 0.3 to 3% by mass, 0.5 to 2% by mass, or 0.7 to 1.5% by mass with respect to the total amount of the ink composition. When the content of the fixing resin is within the above range, the ejection stability and the abrasion resistance tend to be further improved.

### 1.2.1. Acrylic-Based Resin

The acrylic-based resin is a general term for a polymer containing at least a constituent unit derived from an acrylic monomer, and examples thereof include a resin obtained from an acrylic monomer and a copolymer of an acrylic monomer and a monomer other than an acrylic monomer. As the acrylic monomer, a monomer having a (meth)acryloyl group such as (meth)acrylic acid, (meth)acrylate, (meth)acrylamide, or (meth)acrylonitrile can be used. A monomer other than an acrylic monomer may be used as a constituent unit in combination with the acrylic monomer. Examples of the monomer other than an acrylic monomer include vinyl monomers such as styrene.

Since the acrylic-based resin has high affinity with plant oil char CB, by using the acrylic-based resin as the fixing resin, the abrasion resistance tends to be further improved.

The acrylic-based resin may be a self-emulsifying resin. The self-emulsifying acrylic-based resin can be obtained, for example, by the emulsion polymerization of an unsaturated monomer in water in the presence of a polymerization initiator and a surfactant.

Unsaturated monomers include, for example, acrylic acid ester monomers, methacrylic acid ester monomers, aromatic vinyl monomers, vinyl ester monomers, vinyl cyanide compound monomers, halogenated monomers, olefin monomers, and diene monomers, which are generally used in emulsion polymerization. Specific examples thereof include (meth)acrylic acid ester monomers such as methyl (meth)acrylate, ethyl (meth)acrylate, isopropyl (meth)acrylate, n-butyl (meth)acrylate, isobutyl (meth)acrylate, n-amyl(meth)acrylate, isoamyl(meth)acrylate, n-hexyl(meth)acrylate, 2-ethylhexyl (meth)acrylate, octyl (meth)acrylate, decyl(meth)acrylate, dodecyl (meth)acrylate, octadecyl(meth)acrylate, cyclohexyl (meth)acrylate, phenyl (meth)acrylate, benzyl (meth)acrylate, and glycidyl (meth)acrylate; vinyl ester monomers such as vinyl acetate; vinyl cyanide compounds such as acrylonitrile and methacrylonitrile; halogenated monomers such as vinylidene chloride and vinyl chloride; aromatic vinyl monomers such as styrene, α-methylstyrene, vinyltoluene, 4-t-butylstyrene, chlorostyrene, vinyl anisole, and vinyl naphthalene; olefins such as ethylene and propylene; dienes such as butadiene and chloroprene; vinyl monomers such as vinyl ether, vinyl ketone, and vinylpyrrolidone; unsaturated carboxylic acids such as acrylic acid, methacrylic acid, itaconic acid, fumaric acid, and maleic acid; acrylamides such as acrylamide, methacrylamide, and N,N′-dimethylacrylamide; and hydroxyl group-containing monomers such as 2-hydroxyethyl (meth)acrylate and 2-hydroxypropyl (meth)acrylate.

In addition, a crosslinkable monomer having two or more polymerizable double bonds may also be used. Examples of crosslinkable monomers having two or more polymerizable double bonds include di(meth)acrylate compounds such as polyethylene glycol di(meth)acrylate, triethylene glycol di(meth)acrylate, 1,3-butylene glycol di(meth)acrylate, 1,4-butylene glycol di(meth)acrylate, 1,6-hexanediol di(meth)acrylate, neopentyl glycol di(meth)acrylate, 1,9-nonanediol di(meth)acrylate, polypropylene glycol di(meth)acrylate, 2,2′-bis(4-(meth)acryloxypropyloxyphenyl)propane, and 2,2′-bis(4-(meth)acryloxydiethoxyphenyl)propane; tri(meth)acrylate compounds such as trimethylolpropane tri(meth)acrylate, trimethylolethane tri(meth)acrylate, and tetramethylolmethane tri(meth)acrylate; tetra(meth)acrylate compounds such as ditrimethylol tetra(meth)acrylate, tetramethylolmethane tetra(meth)acrylate, and pentaerythritol tetra(meth)acrylate; hexa(meth)acrylate compounds such as dipentaerythritol hexa(meth)acrylate; methylenebisacrylamide, and divinylbenzene.

In the emulsion polymerization, a chain transfer agent, a neutralizer, and the like may be used in addition to the polymerization initiator and the surfactant. Examples of the neutralizing agent include ammonia and inorganic alkali hydroxides such as sodium hydroxide and potassium hydroxide.

The content of the acrylic-based resin is preferably 0.1 to 10% by mass, 0.1 to 5% by mass, 0.3 to 3% by mass, 0.5 to 2% by mass, or 0.7 to 1.5% by mass with respect to the total amount of the ink composition. When the content of the acrylic-based resin is within the above range, the ejection stability and the abrasion resistance tend to be further improved.

### 1.2.2. Urethane-Based Resin

The urethane-based resin is a general term for a resin having a urethane skeleton, and refers to a resin containing a urethane bond, a urea bond, or an allophanate bond formed by the reaction of an isocyanate group with an active hydrogen-containing group such as a hydroxyl group, an amino group, a urethane bonding group, or a carboxyl group. In addition, examples of the urethane-based resin also include a polyether urethane resin containing an ether skeleton in the main chain, a polyester urethane resin containing an ester skeleton in the main chain, and a polycarbonate urethane resin containing a carbonate skeleton in the main chain, in addition to the urethane skeleton. By using the urethane-based resin as the fixing resin, the abrasion resistance tends to be further improved.

The urethane-based resin may be a self-emulsifying resin. Examples of the urethane-based self-emulsifying fixing resin include a urethane-based resin to which a hydrophilic group or a hydrophilic segment has been imparted. Examples of commercially available products of urethane-based self-emulsifying fixing resins include SUPERFLEX 460 (trade name, isocyanate carbonate-based urethane-based resin, manufactured by DKS Co., Ltd.).

The content of the urethane-based resin is preferably 0.1 to 10% by mass, 0.1 to 5% by mass, 0.3 to 3% by mass, 0.5 to 2% by mass, or 0.7 to 1.5% by mass with respect to the total amount of the ink composition. When the content of the urethane-based resin is within the above range, the ejection stability, the clogging recoverability, and the abrasion resistance tend to be further improved.

The polyester-based resin may be a resin having a polyester structure in the skeleton of the resin. The polyether-based resin may be a resin having a polyether structure in the skeleton of the resin. The polyolefin-based resin may be a resin having a polyolefin structure in the skeleton of the resin.

### 1.3. Solvent

The ink composition in the present embodiment contains a solvent. The solvent is a medium having the pigment, the fixing resin, and the like dispersed or dissolved therein, and is a liquid component. The solvent contains at least water, and may contain an organic solvent or the like. When simply referred to as “solvent”, the term means a solvent as described above.

### 1.3.1. Organic Solvent

The ink composition in the present embodiment may contain an organic solvent as a solvent. The organic solvent in the present embodiment preferably includes an organic solvent A having an octanol-water partition coefficient logP_{ow} value of 0 to 1. Because of the presence of the organic solvent A in the ink composition, when the drying of the ink progresses, and the organic component content becomes predominant, the fixing resin and the pigment are more easily dissolved in the ink, and the storage stability and the clogging recoverability tend to be further improved. In addition, since the fixing resin and the pigment are easily bonded to each other in the organic solvent A in a process in which the ink dries on the recording medium, the abrasion resistance tends to be further improved. The ink composition in the present embodiment may contain an organic solvent B having a logP_{ow} value other than 0 to 1, if necessary. The organic solvent B is an organic solvent other than the organic solvent A. The octanol-water partition coefficient logP_{ow} value is also referred to as octanol-water partition coefficient, logP_{ow} value, or the like.

The logP_{ow} value of the organic solvent A is preferably 0.1 to 1, 0.2 to 0.9, 0.3 to 0.8, 0.4 to 0.7, or 0.5 to 0.6. When the logP_{ow} value is 0 or more, the solubility of the fixing resin becomes higher, and when the logP_{ow} value is 1 or less, the compatibility with water tends to be more excellent. Therefore, when the logP_{ow} value is within the above range, the storage stability, the abrasion resistance, and the clogging recoverability of the ink composition tend to be further improved.

In the present embodiment, the octanol-water partition coefficient logP_{ow} value refers to a value defined by OECD Test Guideline 107. The octanol-water partition coefficient is expressed as logP_{ow}, logK_{ow}, or the like. A higher logP_{ow} value indicates higher hydrophobicity, and a lower logP_{ow} value indicates higher hydrophilicity.

The logP_{ow} value of a compound can be determined by various methods, and can be determined, for example, by measurement according to the measurement method specified in JIS Z 7260-117. In addition, it can also be calculated using Hansen Solubility Parameter Software (HSPiP).

The organic solvents A and B are not particularly limited, and examples thereof include monoalcohols, polyols, ethers, amides, and lactam compounds.

Examples of monoalcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxyethanol, benzyl alcohol, and phenoxypropanol.

Polyols are organic solvents having two or more hydroxyl groups. Examples thereof include glycols having two hydroxyl groups and polyols having three or more hydroxyl groups. Examples of glycols include alkanediols and condensates having a structure in which hydroxyl groups between molecules of alkanediols are condensed. Alkanediols are alkanes substituted with two hydroxy groups. Alkanediols preferably have 2 or more carbon atoms, more preferably 4 or more carbon atoms, and still more preferably 5 to 8 carbon atoms. In addition, 1,2-alkanediol is preferable.

Examples of condensates having a structure in which hydroxyl groups between molecules of alkanediols are condensed include a condensate having a structure in which hydroxyl groups between molecules of diols of alkanes having 2 to 4 carbon atoms are condensed.

Examples of glycols include alkane diols such as ethylene glycol, propylene glycol, 1,2-propanediol, 1,2-butanediol, 1,2-pentanediol, 1,2-hexanediol, 1,2-octanediol, 1,3-propanediol, 1,4-butanediol, and 1,6-hexanediol; and condensates having a structure in which hydroxyl groups between molecules of alkanediols are condensed, such as tetramethylene glycol, hexamethylene glycol, diethylene glycol, triethylene glycol, tetraethylene glycol, polyethylene glycol, dipropylene glycol, tripropylene glycol, polypropylene glycol, and (poly)tetramethylene glycol.

Ethers are not particularly limited, and examples thereof include alkyl ethers and glycol ethers. Examples of alkyl ethers include dimethyl ether, methyl ethyl ether, diethyl ether, isopropyl methyl ether, and isopropyl ethyl ether.

Examples of glycol ethers include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of polyols having three or more hydroxyl groups include glycerin. Examples of ketones include acetone, methyl ethyl ketone, and diethyl ketone. Examples of amides include lactam compounds and other amides.

Examples of the lactam compound include 2-pyrrolidone, N-methyl-2-pyrrolidone, N-ethyl-2-pyrrolidone, and N-hydroxyethylpyrrolidone (HEP).

Among the above organic solvents, the organic solvent A is one having an octanol-water partition coefficient logP_{ow} value of 0 to 1. Examples of such organic solvents A include isopropyl methyl ether, diethylene glycol monobutyl ether, triethylene glycol monobutyl ether, 1,2-hexanediol methyl ethyl ketone, isopropyl alcohol, and methyl ethyl ketone.

The content of the organic solvent A is preferably 1 to 15% by mass, 2 to 11% by mass, 4 to 9% by mass, or 5 to 7% by mass with respect to the total amount of the ink composition. When the content of the organic solvent A is within the above range, the storage stability, the abrasion resistance, and the clogging recoverability tend to be further improved.

The organic solvent B may be any of the various organic solvents described above, but is one having an octanol-water partition coefficient logP_{ow} value of less than 0.

The content of the organic solvent B is preferably 0.5 to 20% by mass, 10 to 19% by mass, 12 to 18% by mass, 13 to 17% by mass, or 14 to 16% by mass with respect to the total amount of the ink composition. When the content of the organic solvent B is within the above range, the storage stability, the abrasion resistance, and the clogging recoverability tend to be further improved.

The total content of the organic solvent including the organic solvent A, as well as B if present, is preferably 5 to 45% by mass, 10 to 40% by mass, 15 to 35% by mass, 17 to 30% by mass, or 19 to 25% by mass with respect to the total amount of the ink composition. When the content of the organic solvent is within the above range, the storage stability, the abrasion resistance, and the clogging recoverability tend to be further improved.

### 1.3.2. Water

The ink jet ink composition of the present embodiment is a water-based ink containing water. “Water-based” refers to a composition containing at least water as a main solvent component of the composition.

The content of water is preferably 40 to 99% by mass, 50 to 90% by mass, 55 to 85% by mass, 60 to 80% by mass, or 65 to 75% by mass with respect to the total amount of the ink jet ink composition. When the content of water is set within the above range, the storage stability, the abrasion resistance, and the clogging recoverability tend to be further improved.

### 1.4. Surfactant

The ink composition in the present embodiment may contain a surfactant. The surfactant is not particularly limited, and examples thereof include a silicone-based surfactant, an acetylene glycol-based surfactant, and a fluorine-based surfactant.

The acetylene glycol-based surfactant is not particularly limited, and examples thereof include alkylene oxide adducts of 2,4,7,9-tetramethyl-5-decyne-4,7-diol and 2,4,7,9-tetramethyl-5-decyne-4,7-diol. Examples of commercially available products of acetylene glycol-based surfactants include Olfine E1010, EXP4200, EXP4300, Surfynol SE, Surfynol 440, Surfynol 104, and Surfynol 465 (trade name, manufactured by Nissin Chemical Industry Co., Ltd.).

The fluorine-based surfactant is not particularly limited, and examples thereof include perfluoroalkyl sulfonic acid salts, perfluoroalkyl carboxylic acid salts, perfluoroalkyl phosphoric acid esters, perfluoroalkyl ethylene oxide adducts, perfluoroalkyl betaines, and perfluoroalkyl amine oxide compounds.

The silicone-based surfactant is not particularly limited, and examples thereof include polysiloxane-based compounds and polyether-modified organosiloxanes. Examples of commercially available products of silicone-based surfactants include BYK-306, BYK-307, BYK-333, BYK-341, BYK-345, BYK-346, BYK-348, BYK-UV3500, BYK-UV3510, BYK-UV3530, and BYK-UV3570 (trade name, manufactured by BYK).

The content of the surfactant is preferably 0.1 to 3% by mass, 0.3 to 2% by mass, or 0.5 to 1.5% by mass with respect to the total amount of the ink composition. When the content of the surfactant is within the above range, the storage stability, the ejection stability, and the clogging recoverability tend to be improved.

### 1.5. pH Adjuster

The ink jet ink composition in the present embodiment may contain a pH adjuster. The pH adjuster is not particularly limited, and examples thereof include inorganic acids such as sulfuric acid, hydrochloric acid, and nitric acid; inorganic bases such as lithium hydroxide, sodium hydroxide, potassium hydroxide, and ammonia; organic acids such as adipic acid, citric acid, and succinic acid; and organic bases such as triethanolamine, diethanolamine, monoethanolamine, triisopropanolamine, diisopropanolamine, and trishydroxymethylaminomethane.

The content of the pH adjuster is preferably 0.1 to 3% by mass, 0.3 to 2% by mass, or 0.5 to 1.5% by mass with respect to the total amount of the ink composition. When the content of the pH adjuster is within the above range, the storage stability, the ejection stability, and the clogging recoverability tend to be improved.

### 1.6. Other Components

The ink composition may contain components other than the components described above. As the other components, various additives such as a dissolution aid, a viscosity modifier, an antioxidant, a preservative, a fungicide, and a corrosion inhibitor can be added as appropriate.

### 2. Recording Method

An ink jet recording method in the present embodiment includes an attaching step of, using a predetermined ink jet head, ejecting the ink jet ink composition described above from the ink jet head to attach the ink jet ink composition to a recording medium.

### 3. Recording Apparatus

A recording apparatus in the present embodiment includes the ink composition described above and an ink jet head having a nozzle that ejects the ink composition described above onto a recording medium, and preferably further includes a supply flow path through which the ink composition described above flows and which is connected to the ink jet head, and a filter unit provided in the supply flow path of the ink jet head.

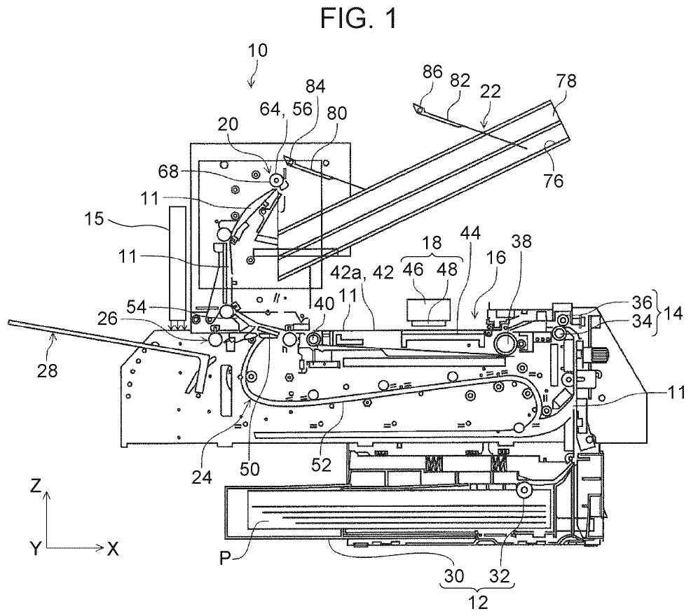

FIG. 1 shows an example of an ink jet recording apparatus that can be used in the present embodiment. The ink jet recording apparatus according to the present embodiment will be described in more detail with reference to FIG. 1. In the X-Y-Z coordinate system shown in FIG. 1, the X direction indicates the length direction of the recording medium, the Y direction indicates the width direction of the recording medium in a transport path in the recording apparatus, and the Z direction indicates the apparatus height direction.

A recording apparatus 10 is, as an example, a line type ink jet printer capable of performing high-speed and high-density printing. The recording apparatus 10 includes a feeding section 12 storing a recording medium P such as paper, a transport section 14, a belt transport section 16, a recording section 18, a face-down (Fd) discharge section 20 as “discharge section”, a face-down (Fd) mounting section 22 as “mounting section”, a reversing path section 24 as “reversing transport mechanism”, a face-up (Fu) discharge section 26, and a face-up (Fu) mounting section 28.

The feeding section 12 is disposed at the lower portion of the apparatus in the recording apparatus 10. The feeding section 12 includes a feeding tray 30 storing the recording medium P and a feeding roller 32 feeding the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported downstream in the transport path 11 in the belt transport section 16.

The recording section 18 includes a line type ink jet head 48 and a head holder 46 holding the ink jet head 48. The recording section 18 may be a serial type recording section, in which an ink jet head is provided on a carriage reciprocating in the Y-axis direction. The ink jet head 48 is disposed to face the upper section 42a of the endless belt 42 supported by the support 44. When the recording medium P is transported in the upper section 42a of the endless belt 42, the ink jet head 48 ejects the ink toward the recording medium P, thereby executing recording. The recording medium P is transported by the belt transport section 16 downstream in the transport path 11 while the recording is carried out.

A first branch section 50 is provided downstream in the transport path 11 in the belt transport section 16. The first branch section 50 is configured to be switchable between the transport path 11, which transports the recording medium P to the Fd discharge section 20 or the Fu discharge section 26, and a reversing path 52 of the reversing path section 24, which reverses the recording surface of the recording medium P and transports again the recording medium P to the recording section 18. The recording surface of the recording medium P, which is switched to the reversing path 52 by the first branch section 50 and is transported, is reversed in a transport process in the reversing path 52, and the recording medium P is transported again to the recording section 18 such that the surface opposite to the initial recording surface faces the ink jet head 48.

A second branch section 54 is further provided downstream of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and mounted on the Fd mounting section 22. At this time, the recording medium P is mounted such that the recording surface thereof faces the Fd mounting section 22. In addition, the recording medium P transported toward the Fu discharge section 26 in the second branch section 54 is discharged from the Fu discharge section 26 and mounted on the Fu mounting section 28. At this time, the recording medium P is mounted such that the recording surface thereof faces the side opposite to the Fu mounting section 28.

### 4. Recording Medium

The recording medium used in the present embodiment is not particularly limited, and examples thereof include an absorbent recording medium, a low-absorbent recording medium, and a non-absorbent recording medium. The absorbent recording medium is preferable.

Examples of the absorbent recording medium include plain paper, such as electrophotographic paper having high ink permeability, and ink jet dedicated paper including an ink absorbing layer formed of silica particles or alumina particles or an ink absorbing layer formed of a hydrophilic polymer such as polyvinyl alcohol or polyvinylpyrrolidone.

Examples of the low-absorbent recording medium include art paper, coated paper, and cast paper, which have relatively low ink permeability and are used in general offset printing.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced by the vapor deposition of these various metals, and plates of alloys such as stainless steel and brass; and recording media in which films of plastics such as polyvinyl chloride, polyethylene, polypropylene, polyethylene terephthalate (PET), polycarbonate, polystyrene, and polyurethane are bonded (applied) onto paper substrates.

### 5. Recorded Matter

A recorded matter of the present embodiment is obtained by attaching the ink composition described above to the recording medium. The recorded matter of the present embodiment using the ink composition described above can be recorded with an ink having excellent storage stability, color developability, transfer resistance, abrasion resistance, clogging recoverability, and bubble dischargeability.

### 6. Ink Set

An ink set of the present embodiment is a set of two or more inks having at least the ink jet ink composition described above, and is used for recording as a set. The ink set may have other ink compositions that exhibit different colors than the ink jet ink compositions described above. Examples include a cyan ink, a yellow ink, and a magenta ink. This enables color printing.

### 7. Pigment Dispersion Liquid

A pigment dispersion liquid of the present embodiment is a pigment dispersion liquid for use in preparing an ink jet ink composition. The pigment dispersion liquid contains a pigment that is bio-derived carbon black and a solvent, in which the pigment is a resin-dispersed pigment dispersed with a crosslinked resin, and the solvent contains water. The pigment dispersion liquid is a water-based pigment dispersion liquid.

An ink jet ink composition is prepared using this pigment dispersion liquid and other components necessary for the ink jet ink composition. The pigment dispersion liquid is also referred to as pigment dispersion.

The pigment and the solvent are the same as those contained in the ink jet ink composition of the present embodiment described above. Since the pigment dispersion liquid contains the pigment and solvent described above, by preparing an ink jet ink composition using this pigment dispersion liquid, an ink jet ink composition containing the pigment and solvent described above can be easily prepared, which is preferable. The ink jet ink composition may be the ink jet ink composition of the present embodiment described above.

The pigment dispersion liquid may contain, if necessary, components which may be contained in the ink jet ink composition of the present embodiment described above.

### EXAMPLES

Hereinafter, the present disclosure will be described in more detail with reference to examples and comparative examples. The present disclosure is not limited by the following examples in any way.

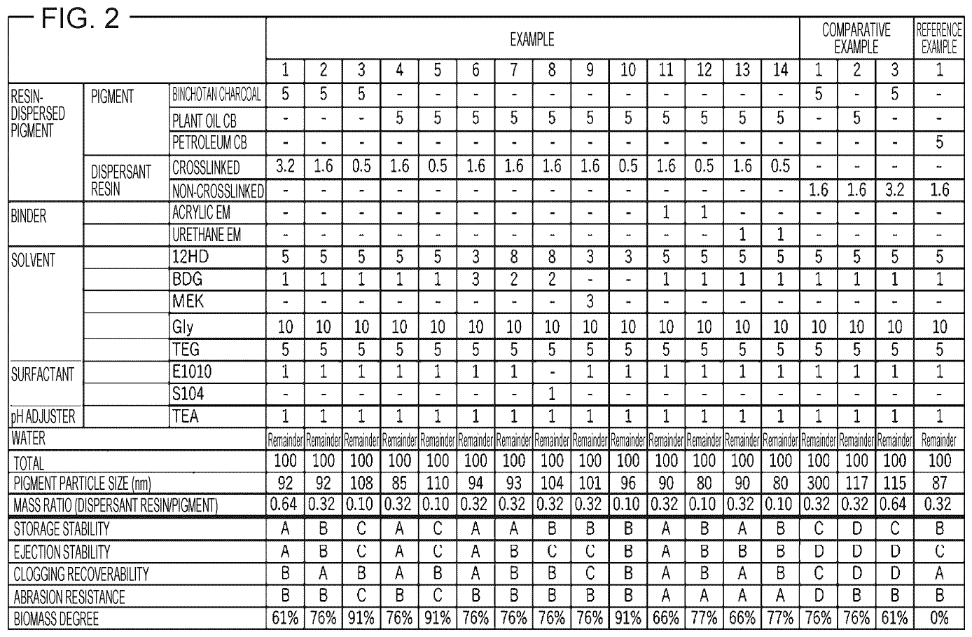

FIG. 2 shows Table 1 showing the compositions of the respective ink compositions of the examples and comparative examples and the evaluation results thereof.

### 1. Preparation of Ink Jet Ink Composition

Dispersion liquids are prepared by mixing and stirring so as to have the compositions described in Table 1 to obtain the ink jet ink compositions of the respective examples. The numerical value of each of the components shown in each example in the table represents % by mass unless otherwise specified. In addition, in the tables, each numerical value represents % by mass of the solids in the component (for the solvent, the value represents the amount of the solvent component).

Details of the product components used in Table 1 are as follows.

### Pigment

Binchotan charcoal, plant oil char, petroleum CB (see the preparation examples below)

### Dispersant Resin

Crosslinked, non-crosslinked (dispersant resin, see the preparation examples below)

### Fixing Resin

Acrylic EM (see the preparation examples below)
Urethane EM (trade name “SUPERFLEX 460”, manufactured by DKS Co., Ltd.)

### Organic Solvent

12HD (1,2-hexanediol, logP_{ow} value: 0.57)
BDG (diethylene glycol monobutyl ether, logP_{ow} value: 0.56)
MEK (methyl ethyl ketone, logP_{ow} value: 0.29)
Gly (glycerin, logP_{ow} value: −1.76)
TEG (triethylene glycol, logP_{ow} value: −1.75)

### Surfactant

E1010 (trade name “OLFINE E1010”, acetylene glycol-based surfactant, manufactured by Nissin Chemical Industry Co., Ltd.)
S104 (trade name “Surfynol 104”, acetylene glycol-based surfactant, manufactured by Nissin Chemical Co., Ltd.)

### pH Adjuster

TEA (triethanolamine)

### Water

Ion-exchanged water

### 1.1. Preparation of Crosslinked Resin-Dispersed Pigment Preparation of Resin Solution

A monomer mixed solution is prepared by mixing 31 parts by mass of acrylic acid and 69 parts by mass of styrene. In a reaction vessel, 5 parts by mass of methyl ethyl ketone, 0.25 part by mass of 3-mercaptopropionic acid (polymerization chain transfer agent), and 10% by mass of the monomer mixed solution (3.1 parts by mass of acrylic acid and 6.9 parts by mass of styrene) are mixed, and nitrogen gas replacement is sufficiently performed. Next, in a dropping funnel, a mixed solution of the remaining 90% by mass of the monomer mixed solution (28.9 parts by mass of acrylic acid and 62.1 parts by mass of styrene), 2.25 parts by mass of 3-mercaptopropionic acid, 75 parts by mass of methyl ethyl ketone, and 1.5 parts by mass of 4,4′-azobis(4-cyanovaleric acid) (azo-based radical polymerization initiator, manufactured by FUJIFILM Wako Pure Chemical Corporation) is prepared. Under a nitrogen atmosphere, the inside of the reaction vessel is heated to 77° C. with stirring, and the mixed solution in the dropping funnel is added dropwise over 5 hours. After the completion of dropwise addition, a solution prepared by dissolving 0.5 part by mass of 4,4′-azobis(4-cyanovaleric acid) in 5 parts by mass of methyl ethyl ketone is further added, and the mixture is further reacted at 77° C. for 2 hours to obtain a resin solution of a resin having a carboxyl group.

### Preparation of Resin Dispersion

To 24 parts by mass of a resin obtained by drying the resin solution obtained above under reduced pressure, 200 parts by mass of ion-exchanged water and 9.7 parts by mass of a 5N aqueous sodium hydroxide solution (sodium hydroxide solids content: 16.9% by mass) are added, and neutralization is performed such that the ratio of the number of moles of sodium hydroxide to the number of moles of carboxy groups in the resin is 40% (the degree of neutralization: 40 mol %). The aqueous solution is heated at 90° C. for 5 hours with stirring at 150 rpm to obtain a resin dispersion.

### Preparation of Pigment Dispersion

Binchotan charcoal (manufactured by Kiriya Chemical Co., Ltd.) is added to the obtained resin dispersion so that the mass ratio between the previously added resin and the Binchotan charcoal is as shown in Table 1, and the mixture is stirred for 60 minutes at 20° C. using Ultra Disper (manufactured by Asada Iron Works Co., Ltd.) under the condition that the dispersing blade is rotated at 7,000 rpm. The obtained mixture is subjected to a dispersion treatment for 10 passes with a microfluidizer (manufactured by Microfluidics Co., Ltd.) at a pressure of 200 MPa. The obtained dispersion liquid is filtered with a 25-mL capacity needleless syringe (manufactured by Terumo Corporation) equipped with a 5-μm filter (acetylcellulose membrane, outer diameter: 2.5 cm, manufactured by Fujifilm Corporation) to remove coarse particles. Ion-exchanged water is then added to adjust the solids concentration to 22% by mass to obtain a pigment dispersion. When plant char is used as a pigment, carbon black (plant oil-based, manufactured by Orion Engineered Carbons) is used instead of Binchotan charcoal. When petroleum-derived CB (petroleum-derived carbon black) is used as a pigment, petroleum-derived carbon black (C.I. Pigment Black 7, manufactured by Mitsubishi Chemical Corporation) is used instead of Binchotan charcoal.

### Crosslinking of Resin

100 parts by mass of the pigment dispersion obtained above is put into a glass bottle with a screw cap, and 1.27 parts by mass of trimethylolpropane polyglycidyl ether (Denacol EX 321, manufactured by Nagase ChemteX Corporation, molecular weight: 302, epoxy equivalent: 139, water solubility: 27%) as a crosslinking agent having three epoxy groups in one molecule is added such that 40 mol % of all carboxy groups in the resin are crosslinked. The glass bottle is tightly stopped, and the mixture is heated at 70° C. for 5 hours while being stirred with a stirrer. After a lapse of 5 hours, the temperature is lowered to room temperature, and filtration is performed with a 25-mL capacity needleless syringe (manufactured by Terumo Corporation) equipped with a 5-μm filter (acetylcellulose membrane, outer diameter: 2.5 cm, manufactured by Fujifilm Corporation) to obtain a crosslinked resin-dispersed pigment.

### 1.2. Preparation of Non-Crosslinked Resin-Dispersed Pigment

A non-crosslinked resin-dispersed pigment was prepared in the same manner as for the above crosslinked resin-dispersed pigment, except that the step of “Crosslinking of Resin” was not performed.

### 1.3. Preparation of Acrylic EM

Into a reaction vessel equipped with a stirrer, a reflux condenser, a dropping device, and a thermometer, 900 g of ion-exchanged water and 3 g of sodium lauryl sulfate are charged, and the mixture is heated to 70° C. while being stirred and replaced with nitrogen. While maintaining the internal temperature at 70° C., 4 g of potassium persulfate was added as a polymerization initiator and dissolved, and then an emulsion prepared in advance by adding 20 g of acrylamide, 130 g of styrene, 780 g of 2-ethylhexyl acrylate, 30 g of methacrylic acid, and 2 g of ethylene glycol dimethacrylate to 450 g of ion-exchanged water and 3 g of sodium lauryl sulfate with stirring was continuously added dropwise to the reaction solution over 4 hours. After the completion of dropwise addition, the mixture was aged for 3 hours. The resin dispersion was cooled to room temperature, and ion-exchanged water and aqueous ammonia were then added to adjust the solids content to 40% by weight and the pH to 8.

### 2. Evaluation Method

### 2.1. Storage Stability

Each ink composition is left to stand in an environment of 60° C. for one week. Thereafter, the variation range of the volume-average particle size of the pigment particles in the ink after being left to stand to the volume-average particle size of the pigment particles in the ink before being left to stand is calculated, and evaluated according to the following criteria. The volume-average particle size is measured using ELSZ-1000 (trade name, dynamic scattering particle size analyzer, manufactured by Otsuka Electronics Co., Ltd.).

### Evaluation Criteria

A: Variation range is less than ±5%.
B: Variation range is ±5% or more and less than ±10%.
C: Variation range is ±10% or more and less than ±20%.
D: Variation range is ±20% or more.

### 2.2. Clogging Recoverability

The ink composition is filled into a modified PX-M791FT printer (manufactured by Seiko Epson Corporation), a nozzle check is performed to confirm that all the nozzles eject the ink composition, and then the printer is left to stand with the head decapped under an environment of 40° C. for 7 days. After standing, the number of times of cleaning until all the nozzles are recovered is evaluated according to the following evaluation criteria.

### Evaluation Criteria

A: The number of times of cleaning is 2 or less.
B: The number of times of cleaning is 3.
C: The number of times of cleaning is 4 or 5.
D: Not recovered after 5 times of cleaning.

### 2.3. Abrasion Resistance

Each ink composition is filled into a modified PX-M791FT printer (manufactured by Seiko Epson Corporation), and 26 letters of the alphabet of 20-point size are recorded on Xerox P paper (copy paper manufactured by Fuji Xerox Co., Ltd., basis weight: 64 g/m², paper thickness: 88 μm) as a recording medium. Immediately after the recording, the recording medium is fixed on a horizontally installed flat surface, and 5 minutes after the recording, the letter portion is rubbed with a line marker “OPTEX CARE” (trade name, manufactured by Zebra Co., Ltd.). Evaluation is then performed according to the following evaluation criteria based on the degree of bleeding of the ink.

### Evaluation Criteria

A: No color bleeding occurs even when rubbed 3 times.
B: No color bleeding occurs when rubbed twice, but color bleeding occurs when rubbed 3 times.
C: No color bleeding occurs when rubbed once, but color bleeding occurs when rubbed twice.
D: Color bleeding occurs when rubbed once.

### 2.4. Ejection Stability

The ink after the above storage stability evaluation is filled into a modified SC-T3150 machine (manufactured by Seiko Epson Corporation), a nozzle check is performed to confirm that all the nozzles eject the ink, and then recording is performed on a recording medium (thin plain paper roll; manufactured by Epson) for 5 hours, followed by a post-recording ejection test.

### Evaluation Criteria

A: The number of non-ejecting nozzles is 3% or less of the total number of nozzles.
B: The number of non-ejecting nozzles is more than 3% and 7% or less of the total number of nozzles.
C: The number of non-ejecting nozzles is more than 7% of the total number of nozzles.

### 2.5. Biomass Degree

The biomass degree of each component of the ink composition is calculated based on the concentration of ¹⁴C, which is an isotope of ¹²C, in accordance with ASTM D6866. ¹⁴C is measured by accelerator mass spectrometry (AMS method). The biomass degree of the solids in the ink composition is calculated based on the biomass degree of each component of the solids in the ink composition.

### 3. Evaluation Results

As shown in Table 1, the examples, which are ink jet ink compositions of the present embodiment containing a pigment that is bio-derived carbon black, in which the pigment is a resin-dispersed pigment dispersed with a crosslinked resin, are all excellent in ejection stability. Further, the storage stability, the clogging recoverability, and the abrasion resistance also tend to be further improved.

On the other hand, the comparative examples, in which the pigment is not a resin-dispersed pigment dispersed with a crosslinked resin, are all inferior in ejection stability. Further, some of them are inferior in storage stability, clogging recoverability, and abrasion resistance.

In addition, in the reference example not containing a pigment that is bio-derived carbon black, although the pigment is not a resin-dispersed pigment dispersed with a crosslinked resin, the ejection stability is not inferior.

What is claimed is:

1. An ink jet ink composition comprising:
a pigment that is bio-derived carbon black; and
a solvent, wherein
the pigment is a resin-dispersed pigment dispersed with a crosslinked resin,
the solvent contains water, and
the ink jet ink composition is a water-based ink.

2. The ink jet ink composition according to claim 1, wherein
the pigment includes plant-derived carbon black.

3. The ink jet ink composition according to claim 1, wherein
the resin is a resin crosslinked with a compound having two or more functional groups of at least one kind selected from the group consisting of an epoxy group, an isocyanate group, an aziridino group, an amino group, and an oxazoline group in the molecule.

4. The ink jet ink composition according to claim 1, wherein
the resin includes an acrylic-based resin.

5. The ink jet ink composition according to claim 1, wherein
the solvent includes an organic solvent A having an octanol-water partition coefficient of 0 to 1.

6. The ink jet ink composition according to claim 1, wherein
the pigment has a volume-average particle size of 110 nm or less.

7. The ink jet ink composition according to claim 1, wherein
the mass ratio of the resin to the pigment is 0.1 to 0.7.

8. The ink jet ink composition according to claim 1, further comprising
a fixing resin.

9. A recording method comprising
an ink attaching step of ejecting the ink jet ink composition according to claim 1 from an ink jet head to attach the ink jet ink composition to a recording medium.

10. An ink set comprising
the ink jet ink composition according to claim 1.

11. A pigment dispersion liquid for use in preparing the ink jet ink composition according to claim 1, the pigment dispersion liquid comprising:
a pigment that is bio-derived carbon black; and
a solvent, wherein
the pigment is a resin-dispersed pigment dispersed with a crosslinked resin,
the solvent contains water, and
the pigment dispersion liquid is a water-based pigment dispersion liquid.
